(19) United States
(12) Patent Application Publication
(10) Pub. No.: US 2024/0088405 A1
(43) Pub. Date: Mar. 14, 2024

(54) METHOD FOR FORMING A HYDROPHILIC SURFACE ON A GRAPHITE-CONTAINING MATERIAL, AND METHOD FOR MANUFACTURING A BIPOLAR PLATE, AND BIPOLAR PLATE, AND FUEL CELL OR FLOW BATTERY HAVING SUCH A BIPOLAR PLATE

(71) Applicant: SCHUNK KOHLENSTOFFTECHNIK GMBH, Heuchelheim (DE)

(72) Inventors: Günter RINN, Lahnau (DE); Hauke VOORMANN, Linden (DE); Sören BAUMANN, Gießen (DE); Mesut ALTUNTAS, Frankfurt (DE)

(73) Assignee: SCHUNK KOHLENSTOFFTECHNIK GMBH, Heuchelheim (DE)

(21) Appl. No.: 18/264,140

(22) PCT Filed: Mar. 3, 2022
(86) PCT No.: PCT/EP2022/055423

§ 371 Date: Aug. 3, 2023

(30) Foreign Application Priority Data
Mar. 11, 2021 (DE) 10 2021 105 963.1
May 26, 2021 (DE) 10 2021 113 591.5

(51) Int. Cl. H01M 8/0213; B23K 26/0622; B23K 26/352; H01M 8/0221; H01M 8/0226; H01M 8/0228; H01M 8/18

(52) U.S. Cl. CPC H01M 8/0213; B23K 26/0624; B23K 26/352; H01M 8/0221; H01M 8/0226; H01M 8/0228; H01M 8/18; B23K 2103/50

(57) ABSTRACT

A method for forming a hydrophilic surface on a graphite-containing material. The surface to be rendered hydrophilic is irradiated with a pulsed laser having a power density of at least 0.5 MW/mm². A bipolar plate, for example, may be rendered hydrophilic in part-regions of its surface in a simple manner and with a low outlay in terms of apparatus.

### FIELD

The present invention relates to a method for forming a hydrophilic surface on a graphite-containing material. The invention relates further to a method for manufacturing a bipolar plate of a fuel cell or of a flow battery. The invention relates additionally to a bipolar plate and to an energy storage arrangement, for example in the form of a fuel cell or a flow battery.

### BACKGROUND

Graphite-containing materials may be used in the widest variety of applications, for example in order to form different structural elements therewith. Physical properties of the graphite contained therein, such as, for example, its high electrical conductivity, mechanical properties, thermal stability and/or chemical stability, may advantageously be used.

In some applications, it may be advantageous if a surface of a structural element produced using a graphite-containing material has specific physical properties on contact with other materials. In particular, it may be advantageous for some applications if that surface is hydrophilic, that is to say interacts strongly with water and thus may readily be wetted with water.

Embodiments of a method for forming a hydrophilic surface on a graphite-containing material and physical properties and/or advantages which may thereby be achieved will be described in detail hereinbelow with reference to a formation of a hydrophilic surface on a bipolar plate formed using graphite-containing material, as may be used in a fuel cell or a flow battery. It should, however, be noted that embodiments of the method described herein may also be used in the manufacture of other structural elements in which at least part-surfaces are to be rendered hydrophilic.

Bipolar plates are intended to perform multiple different functions for fuel cells which, when layered to form stacks, form a core of a fuel cell system. On the one hand, they are to connect adjacent fuel cells together, that is to say connect an anode of one cell to a cathode of an adjacent cell physically and in an electrically conducting manner. On the other hand, a distribution of gas to reaction spaces within the fuel cells is to be able to take place by way of a face of the bipolar plate, that is to say the bipolar plate is to guide reaction gases into reaction zones. For this purpose, the bipolar plate typically has on both sides flow profiles (so-called flow fields), which may be originally formed and/or reshaped, that is to say, for example, milled or pressed in, and through which on one side water flows and on the other side air is supplied. The bipolar plate generally also controls a removal of water vapor or a dissipation of thermal and electrical energy. In addition, the bipolar plate is further to provide for gas separation between adjacent cells, sealing toward the outside, and optionally cooling.

In order to be able to meet the demands which are made of it, at least parts of the surface of the bipolar plate should be able to be wetted as thoroughly as possible with water, that is to say should be highly hydrophilic. By way of example, on a anode side, that is to say on a fuel gas side, the bipolar plate should allow an electrode and a membrane in the fuel cell to be wetted uniformly. On a cathode side, that is to say on an oxygen side, water which is produced during a reaction within the fuel cell should be able to be removed effectively, since otherwise it may block a pore system in the electrode and/or air channels in the bipolar plate. If associated regions of the surface of the bipolar plate are rendered hydrophilic and thus have very good wetting properties, it may be achieved that water is no longer present in a form of drops but instead forms a surface film and may then easily be removed by means of a stream of gas, for example.

Different approaches are known for rendering surfaces of materials hydrophilic.

For example, a surface may be coated with a material having a hydrophilic action. Suitable coating materials are, for example, polar polymers.

A further possibility for forming a hydrophilic surface consists in a treatment with a siloxane-containing plasma, whereby, similarly to a coating or a surface modification, a very thin layer of pyrogenic silica is produced.

A further possibility that is frequently used consists in the direct oxidation of the surface to be rendered hydrophilic. Different methods may be used for this purpose, such as, for example, wet chemical oxidation with strongly oxidizing acids or hydrogen peroxide, dry oxidation in the gas phase, for example with fluorine or sulfur trioxide, atmospheric plasma treatment, low-pressure plasma treatment or corona treatment.

However, most of the known approaches are accompanied by disadvantages or at least problems that are expensive to overcome. For example, a layer applied to the surface of a bipolar plate may increase an electrical contact resistance at the surface of the bipolar plate. In addition, it may be difficult to uniformly coat in some cases very fine structures on the surface of the bipolar plate. Permanent and reliable adhesion of the coating to the surface of the bipolar plate may also be difficult to achieve. Oxidation with highly toxic gases such as fluorine or sulfur trioxide may entail high demands on equipment that is here to be used, since such treatment should generally only be carried out in hermetically sealed systems. In some of the methods mentioned above, such as, for example, plasma treatment or corona treatment, although satisfactory hydrophilicity is often found directly after the treatment, it has frequently been observed that this hydrophilicity is not stable over time and lasts, for example, only for a few hours or days. In addition, it is difficult with many of the known methods to render small-area part-regions of a surface hydrophilic in a purposive and local manner, for example by a complex masking of other part-regions.

EP 2 615 675 A1 and EP 2 960 973 A1 describe methods for producing fuel cell separators in which a surface is first purposively roughened and then irradiated with a laser. The described methods generally require multiple method steps. The methods are thus expensive to carry out or require a significant outlay in terms of apparatus.

### SUMMARY

There may be a need for a method for forming a hydrophilic surface on a graphite-containing material by means of which at least some of the advantages or problems mentioned at the beginning of conventionally known approaches may be avoided or reduced. In particular, there may be a need for such a method in which a structural element produced from the graphite-containing material has a low electrical contact resistance at its surface, in which even fine surface structures may be rendered hydrophilic, in which no highly toxic substances or catalytic poisons need to be used, in which hydrophilicity may be produced in such a manner that it is stable over the long term, and/or which may be carried out easily, with a low outlay in terms of apparatus and/or inexpensively. Furthermore, there may be a need for a method for manufacturing a bipolar plate of a fuel cell or of a flow battery in which, by using the method described herein, part-regions of the bipolar plate may be provided with hydrophilic properties. Furthermore, there may be a need for a bipolar plate which is to be manufactured accordingly, and for an energy storage arrangement, for example in the form of a fuel cell or of a flow battery.

A first aspect of the invention relates to a method for forming a hydrophilic surface on a graphite-containing material, wherein the surface to be rendered hydrophilic is irradiated with a pulsed laser having a power density of at least 0.5 MW/mm², preferably at least 1 MW/mm² or at least 2 MW/mm².

A second aspect of the invention relates to a method for manufacturing a bipolar plate of a fuel cell or of a flow battery, wherein the method comprises: providing a plate-like substrate which, at least adjacent to an exposed surface of the substrate, consists of a graphite-containing material, and forming at least part-regions of the exposed surface as a hydrophilic surface by means of the method according to an embodiment of the first aspect of the invention.

A third aspect of the invention relates to a bipolar plate of a fuel cell or of a flow battery, which bipolar cell which has been manufactured by means of a method according to an embodiment of the second aspect of the invention.

A fourth aspect of the invention relates to an energy storage arrangement, in particular in the form of a fuel cell or of a flow battery, having a bipolar plate according to an embodiment of the third aspect of the invention.

Without limiting the scope of the invention in any way, ideas and possible features relating to embodiments of the invention may be considered to be based, inter alia, on the concepts and findings described hereinbelow.

Briefly and roughly summarized, a basic concept of the idea described herein may be seen in that, surprisingly, it has been observed that the surface of a graphite-containing material develops hydrophilic properties if it is irradiated with a pulsed laser having a comparatively high power density. Although graphite-containing materials have hitherto already been irradiated by means of lasers, the power density of the lasers used here was significantly lower than that of the lasers which are to be used for the invention described herein. On treatment with such lower-power lasers, the surfaces of the graphite-containing material, which in any case are normally quite hydrophobic, generally developed increased hydrophobicity. It was therefore not to be expected that the surface of a graphite-containing material irradiated with a laser, through a suitable choice of properties of the laser used for that purpose, would not be rendered increasingly hydrophobic, but instead would even be rendered hydrophilic.

Possible details of embodiments of the methods and products described herein will be explained hereinbelow.

Graphite, as a carbon-containing material, offers advantageous properties for many applications. For use in bipolar plates, for example, graphite offers very high electrical conductivity together with a high thermal load-bearing capacity and sufficiently high mechanical strength.

For a formation of structural elements such as, for example, bipolar plates there are used, inter alia, graphite-containing materials in which graphite particles are embedded in a polymer matrix. The graphite particles provide the material with desired electrical and/or thermal properties. The polymer matrix serves, inter alia, to mechanically hold the graphite particles together and to transmit the load in the component. The polymer matrix may contain an epoxy resin, for example. The graphite particles thus act as a filler and the polymer matrix acts as a kind of binder. In addition to graphite particles and polymers, the material mixture may also contain further constituents, for example in the form of carbon black, further binders or the like.

Advantageously, the graphite-containing material may have a graphite content of at least 60%, preferably at least 70% or even at least 80%. The percentages may here be based on the volume. Owing to the high graphite content, the material may offer, inter alia, very good electrical conductivity, as is advantageous in particular in the case of use in the formation of bipolar plates.

A polymer content, that is to say a content of the polymer matrix, in the graphite-containing material is preferably at least 20 vol. %, preferably in the range of from 20 to 40 vol. %, more preferably in the range of from 25 to 35 vol. %. In other words, the graphite-containing material, during its treatment with the laser, contains a considerable proportion of polymers, which may serve as binders for graphite particles and/or may be required for mechanical stability and/or gas tightness of the bipolar plate. Expressed differently, the graphite-containing material is preferably neither carbonized nor calcined before it is treated with the laser. Carbonization or calcination of a component of graphite-containing material in most cases leads to considerable shrinkage and/or mechanical stresses in the component in question, so that warping, increased dimensional tolerances and/or fracture may result. Therefore, large components, in particular large-area bipolar plates, often cannot be manufactured using carbonized or calcined graphite-containing material. However, in the method described herein, carbonization or calcination is preferably dispensed with, whereby a manufacture of large-size and/or very thin bipolar plates (e.g. having a length of more than 300 mm or more than 400 mm, a width of more than 100 mm or more than 130 mm and/or a thickness of between 0.3 mm and 2 mm, for example 0.6 mm±0.2 mm) is made possible. Treatment with the laser is preferably carried out in such a manner that the polymeric binder contained in the graphite-containing material is not or not excessively damaged by a high energy input that is thereby introduced but is removed only from the surface of the bipolar plate.

Examples and possible properties of graphite-containing materials are described, inter alia, in the earlier patent application PCT/EP2020/078489 of the applicant. The graphite-containing materials described therein may be processed and rendered hydrophilic on their surface in embodiments of the methods described herein. The content of the earlier application is incorporated herein by reference in its entirety.

It is known that pure graphite does normally not have any polar groups, so that surfaces of the graphite generally have hydrophobic properties.

Hitherto, it has been assumed that, although surfaces of a graphite-containing material may be processed by means of a laser, their hydrophobic properties are in many cases at least not reduced but rather increased thereby. In particular, it has been assumed or observed that microscopic surface textures, as are typically formed when a surface is treated with a laser, have the result that the treated surface develops even more pronounced hydrophobic properties, since such microscopic surface structures typically inhibit wetting with water owing to the lotus effect.

In EP 2 615 675 A1 it is described that a fuel cell separator comprising a combination of graphite powder, epoxy resin, phenolic resin and other constituents is to be treated with a high-power laser in order, inter alia, to influence hydrophilic properties of its surface. However, only details regarding the power and the pulse duration of the laser to be used are described in EP 2 615 675 A1. It is indicated, inter alia, that too short pulse durations of, for example, less than 30 ns are to be avoided, since it is otherwise feared that warping of the substrate may occur. Details of a pulse repetition frequency and/or a cross-sectional area of a laser pulse beam are not given in EP 2 615 675 A1, so that information about power densities effected by the pulse laser cannot be derived from that publication.

Contrary to such expectations or previous observations, it has been observed, surprisingly, by the inventors of the invention described here that a surface of a graphite-containing material is actually more hydrophilic after irradiation with a pulsed laser, which meets certain requirements, than before such irradiation. In other words, a contact angle which water forms with a surface so treated is smaller than before the irradiation. It has here been recognized that it appears to be crucial for improving the hydrophilicity that the pulsed laser irradiates the surface with a power density that lies above a limit value. 0.5 MW/mm² is assumed as such a limit value. Very good hydrophilicity of the treated surface has been observed, for example, on irradiation with pulsed laser light having a power density of at least 1 MW/mm² or in particular at least 1.5 MW/mm². A short pulse laser, during a very short pulse duration, here illuminates a generally very small area of significantly less than 1 mm² for a short time with a very high light power.

Attempts have been made to understand the surprising observation of improved hydrophilicity as a result of irradiation with a high power density. The model outlined below was developed, and assumptions were made about effects brought about by the laser irradiation. However, it should explicitly be noted that the microscopic, that is to say in particular atomic or molecular, interactions underlying the observation are not yet fully understood. Therefore, the following description of the model and of the assumptions is not intended to limit the scope of the invention in any way:

It is assumed that irradiating the graphite-containing material with a very high power density leads to the generation of imperfections, in particular defects, in the graphite. Such imperfections in a crystal lattice could in themselves already influence the hydrophilic properties at the surface of the material. In addition, it is assumed that hydroxyl groups are subsequently able to couple to such imperfections. These hydroxyl groups, owing to their polarity, may presumably significantly increase the hydrophilic properties of the material surface. A coupling of oxygen may also cause similar effects.

In particular, it is assumed that the hydrophilic properties of the treated surface may be increased if the pulsed laser irradiates the surfaces with pulses having a pulse energy per unit area of at least 0.1 J/mm², preferably at least 0.2 J/mm² or even at least 0.3 J/mm².

Expressed differently, the pulsed laser used for treating the surface of the graphite-containing material should emit light pulses in which each individual light pulse radiates a comparatively large amount of energy onto a small area, so that a pulse energy that exceeds a lower limit value of at least 0.1 J/mm² is obtained. The radiated pulse energy may vary locally within the irradiated area, and the mentioned limit value may be an averaged value. A single light pulse may have, for example, an energy of more than 1 mJ. An area irradiated by the light pulse may be approximately circular or rectangular or of another shape and may have, for example, a diameter or lateral dimensions of 0.1 mm or less.

It is supposed that, in addition to the power density, the pulse energy per unit area of the light pulse emitted by the laser also has a considerable influence on the development of hydrophilic properties, and preferably both parameters should exceed certain limit values.

It may be assumed within the scope of the model presented above that, as the pulse energy per unit area increases, a density of imperfections, as may be generated by irradiation with the laser light, may be increased.

However, it is additionally assumed that, during the development of the hydrophilic properties, the surface irradiated with the pulsed laser should be irradiated with pulses having a pulse energy per unit area of less than 1 J/mm², preferably less than 0.8 J/mm² or even less than 0.7 J/mm².

Expressed differently, the pulsed laser used for treating the surface of the graphite-containing material should emit light pulses, the amount of energy of which, based on the irradiated area, should not exceed an upper limit value of 1 J/mm².

It is assumed that, in the case of pulse energies per unit area above such a limit value, thermal effects having a negative impact may occur. In other words, it is assumed that in the case that laser pulses having a very high pulse energy per illuminated area may have the result that the graphite-containing material is locally heated very considerably for a short time and thermal damage to the material may thereby occur.

It is assumed to be advantageous if the pulsed laser irradiates the surface to be rendered hydrophilic with pulses having a pulse duration of less than 10, preferably less than 100 ns or even less than 20 ns or less than 10 ns.

Expressed differently, it is considered to be advantageous to use a nanosecond short pulse laser for irradiating the surface to be rendered hydrophilic. It is here assumed that the desired high power density needs to be radiated and should be radiated for only a very short period of time, in order on the one hand to form the desired hydrophilic properties and on the other hand to avoid negative effects due to the laser radiation.

In particular, it is on the one hand assumed within the scope of the model presented above that impurities may be generated even with very brief, highly intensive illumination. On the other hand, it is assumed that, with excessively long illumination, excessively pronounced local heating of the material and, associated therewith, negative thermal effects may occur. In particular, it has been observed that, with pulse durations of more than 20 ns or with pulse durations of more than 50 ns, a disrupted surface and/or an increased electrical contact resistance may occur at the lasered surface depending on the chosen pulse energy, size of the laser spot, pulse frequency and/or scan speed.

Preferably, it is desirable to illuminate the surface with pulses having a pulse duration of more than 1 ns, preferably more than 5 ns. Although it has been observed that the hydrophilic properties may also be improved on irradiation with even shorter pulse durations, special ultra-short pulse lasers are generally necessary for generating such even shorter pulse durations in the region of picoseconds or even femtoseconds, and such lasers may be expensive and/or maintenance-intensive.

It is assumed that it is sufficient within the scope of the method proposed herein to irradiate the surface to be rendered hydrophilic with laser light pulses of a sufficiently powerful nanosecond laser. Such nanosecond lasers are available relatively inexpensively and/or may be operated with low maintenance. For example, it is possible to use nanosecond fiber lasers which are designed for large-scale use and which may generate short laser pulses having a high power density.

Preferably, the pulsed laser may irradiate the surface to be rendered hydrophilic with a pulse frequency of less than 100 kHz, preferably less than 50 kHz or even less than 30 kHz.

The pulse frequency is understood as being the frequency with which the laser pulses are periodically repeated. It is assumed that it has a positive effect on the method that is to be carried out if the pulse frequency remains below an upper limit. Although a surface to be processed may be scanned particularly quickly with a very high pulse frequency by scanning along the surface, it is assumed that, on irradiation with a very high power density, material may be superficially detached from the irradiated surface and may form a kind of dust cloud. At very high pulse frequencies, that is to say in the case of pulses that follow one another very closely in terms of time, this dust cloud could lead to partial absorption of the radiated light and thus to reduced effectiveness of the laser pulse.

The pulsed laser may irradiate the surface to be rendered hydrophilic preferably with wavelengths in a range of from 800 nm to 1500 nm, preferably from 1000 nm to 1200 nm.

On the one hand, radiated laser light of such wavelengths, that is to say in the near infrared range, may typically readily be absorbed by graphite-containing material, in particular may preferably be absorbed close to the surface. On the other hand, infrared lasers are generally available inexpensively and are simple to use.

As an additional measure, the surface to be rendered hydrophilic may be exposed to a reactive gas atmosphere during the irradiation.

The reactive gas atmosphere may promote the formation of hydroxyl groups or other polar chemical compositions on the surface irradiated by the laser. The reactive gas atmosphere may comprise, for example, radicals, in particular nitrogen radicals and/or oxygen radicals. The reactive gas atmosphere may have an ambient pressure, that is to say a pressure of typically 1013±50 hPa. Alternatively, the gas atmosphere may have a reduced or elevated pressure. In addition, the gas atmosphere may be at an ambient temperature, that is to say a temperature of typically 25±15° C. Alternatively, the gas atmosphere may have a lower or higher temperature.

Preferably, the pulsed laser which is used to make the material surface more hydrophilic is additionally also used to remove from the graphite-containing material a superficial polymer layer and/or surface layer which consists of a material other than the graphite-containing material.

As has already been described above, materials in which electrically highly conductive graphite powder is embedded in a matrix of a polymer material may in particular be used for forming bipolar plates. Typically, when a bipolar plate is manufactured from such a material, a thin polymer layer similar to a surface skin forms on the surface. In addition or alternatively, a surface layer which consists of a material other than the graphite-containing material may form on the surface of the graphite-containing material. Such a surface layer may, for example, contain or consist of additives or external mold release agents. The polymer layer or the surface layer may result in disadvantageous electrical properties, for example by increasing a contact resistance between the surface of the graphite-containing material and adjacent material such as, for example, an electrolyte or a reaction partner fluid. In order to expose the compressed graphite beneath such a layer and thus, inter alia, reduce an electrical contact resistance with respect to an adjacent material such as, for example, an electrolyte, this superficial polymer layer and/or surface layer must generally be removed at least in some regions. It has been recognized that, advantageously, the same laser may be used for this purpose as is also used to bring about, as described herein, the more hydrophilic surface properties.

In particular, it has been observed that the removal of the polymer layer and/or surface layer may be carried out with same laser parameters as the formation of the hydrophilic surface.

Expressed differently, it has been recognized that the superficial polymer layer on the substrate may be removed using the same laser and the same laser parameters as may also be used to bring about the more hydrophilic surface properties. Thus, preferably in a single, joint process step, it is possible both to remove the superficial polymer layer and/or disadvantageous surface layer from the substrate and to modify the underlying portion of the graphite-containing material in such a manner that it develops more hydrophilic properties.

In summary, by means of the method presented herein, a surface of a structural element produced using graphite-containing material may be rendered hydrophilic in some regions or over its entire surface and/or at the same time a disadvantageous superficial polymer layer or surface layer may be removed with a comparatively low outlay in terms of apparatus. To this end, there may advantageously be used a pulsed laser which, for this purpose, must fulfil certain conditions, in particular in respect of a minimum power density that is to be provided, but which nevertheless may be provided inexpensively and in an industrially tested manner. In particular, there may be used for this purpose a pulsed laser which, for example in the processing of the graphite-containing material or in the manufacture of bipolar plates, may also be used for other purposes, for example for removing a superficial polymer layer from the graphite-containing material. Ideally, sufficient hydrophilic properties of the surface may here be brought about substantially or solely by the described irradiation with the high-power pulsed laser. In other words, additional measures may preferably be dispensed with. For example, preceding processing steps such as, for example, roughening of the surface to be rendered hydrophilic may be unnecessary. Furthermore, subsequent processing steps such as, for example, further roughening, coating, oxidation, plasma treatment or corona treatment may be unnecessary.

Embodiments of the method presented herein may, inter alia, advantageously be used in the manufacture of a bipolar plate to provide at least part-regions of the bipolar plate with a hydrophilic surface. A plate-like substrate may here consist wholly of graphite-containing material or may have graphite-containing material at least on one of its surfaces. An exposed surface of this material may then be modified in the described way by irradiation with laser pulses such that it has hydrophilic properties. A bipolar plate manufactured in that manner may advantageously be used in a fuel cell or a flow battery, which serves as an energy storage arrangement.

It should be noted that possible features and advantages of embodiments of the invention are explained herein partly with reference generally to a method for forming a hydrophilic surface on a graphite-containing material and partly with reference to a method for manufacturing a bipolar plate and to a bipolar plate manufactured in accordance with the method and an energy storage arrangement equipped therewith. A person skilled in the art will recognize that the features described for individual embodiments may be suitably transferred to other embodiments in an analogous manner, may be adapted and/or interchanged to arrive at further embodiments of the invention and possibly synergistic effects.

### BRIEF DESCRIPTION OF THE DRAWINGS

Advantageous embodiments of the invention will be explained further hereinbelow with reference to the accompanying drawings, and neither the drawings nor the explanations are to be construed as limiting the invention in any way.

FIG. 1 shows a bipolar plate during a method according to an embodiment of the present invention.

FIG. 2 shows an energy storage arrangement having a fuel cell according to an embodiment of the present invention.

The figures are merely schematic and not to scale. Identical reference numerals in the various drawings denote identical features or features having the same effect.

### DETAILED DESCRIPTION

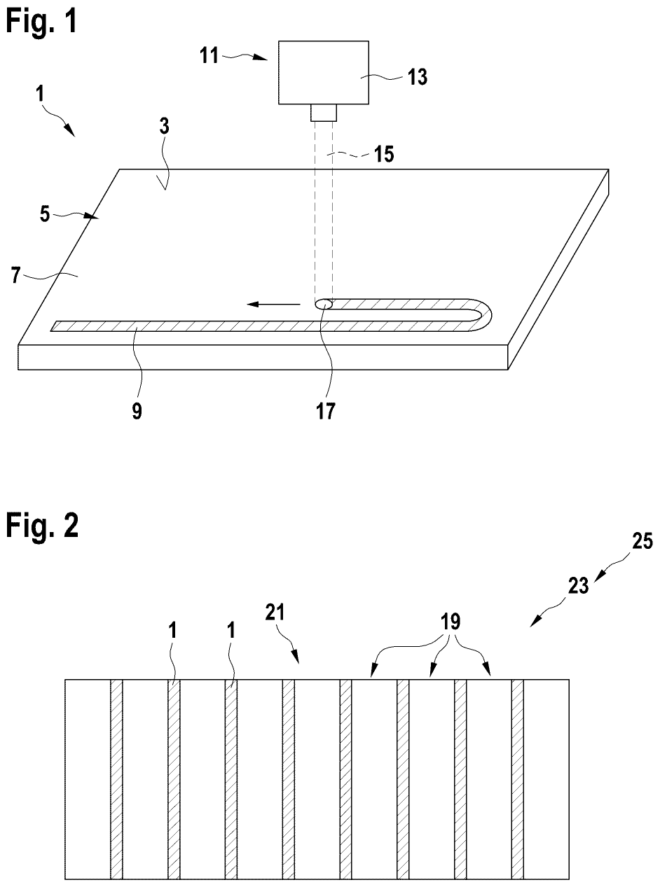

FIG. 1 shows, in a greatly simplified manner, a bipolar plate 1 while it is being treated by a method according to the invention in order to render a surface 3 hydrophilic.

The bipolar plate 1 here has a plate-like substrate 5. At least adjacent to the exposed surface 3, the substrate 5 consists of a graphite-containing material 7. The graphite-containing material 7 contains graphite particles. The graphite particles are typically held together by a matrix of polymer material. On one surface, the substrate 5 may have a superficial polymer layer (not illustrated in the figure for reasons of clarity), which may have been formed, for example, during production of the substrate 5. The bipolar plate 1 may be designed structurally and/or functionally in the same or a similar way to conventional bipolar plates.

In order to render at least part-regions 9 of the exposed surface 3 hydrophilic, these part-regions 9 are irradiated by means of a pulsed laser 11. The pulsed laser 11 may be, for example, a nanosecond fiber laser 13. The pulsed laser 11 may direct a pulsed laser beam 15 onto an exposure region 17 on the surface 3 of the substrate 5. The laser beam 15 and the exposure region 17 may gradually be displaced along the surface 3 in order to illuminate the part-regions 9 that are to be rendered hydrophilic. The part-regions 9 may be, for example, of elongate form and may form, for example, the base of a channel structure in which, during operation of a fuel cell or of a flow battery, water is to be guided along the surface of the bipolar plate 1.

The laser beam 15 strikes the exposure region 17 with a power density of 0.5 MW/mm² or more. Each individual pulse preferably has a pulse energy per unit area of more than 0.1 J/mm² but less than 1 J/mm². The pulse may have a pulse duration of, for example, between 5 ns and 20 ns. Pulses may be repeated with a pulse frequency of, for example, between 20 kHz and 40 kHz. The laser beam 15 may be emitted with a wavelength of, for example, 1064 nm. During the irradiation, the substrate 5 may be exposed to a reactive gas atmosphere. In the same working step or, optionally, in a separate working step, the laser 11 may also be used to remove a superficial polymer layer from the substrate 5. The laser 11 may here preferably be operated with the same laser parameters as are used to achieve the increased hydrophilic surface properties.

The bipolar plate 1 may be used, for example, in a fuel cell 19, as is shown schematically in FIG. 2. Adjacent fuel cells 19 in a cell stack 21 of a fuel cell system 23 serving as an energy storage arrangement 25 may here be separated from one another, electrically connected to one another and supplied with fuel by means of bipolar plates 1.

The background as well as possible configurations and/or advantages of embodiments of the invention set out herein will again be described hereinbelow, in some cases with a different wording, and this description is to be construed merely as providing further explanation but not as limiting in any way.

The invention relates, inter alia, to a method for producing a bipolar plate for a flow battery, fuel cell or the like, and to a bipolar plate produced by the method. The invention relates further to a fuel cell, in particular a fuel cell bundle (stack), or a flow battery, in particular a redox flow battery, having a bipolar plate according to the invention. The invention relates additionally to the use of a laser, in particular an ultrashort pulse laser, in the production of a bipolar plate.

Method for producing hydrophilic surfaces on graphitic materials, in particular on bipolar plates of graphite-filled polymers for use in fuel cells. The performance and reliability of fuel cells is dependent to a large extent on the water management in the cells. On the anode side, that is to say the fuel gas side, uniform wetting of the electrode and of the membrane must be ensured, while on the cathode side, that is to say the oxygen side, the water that is produced in the reaction must effectively be removed, since excess water may otherwise block the pore system in the electrode and the air channels in the bipolar plate.

Typically, this requires bipolar plates with hydrophilic surfaces. Very good wetting properties have the result that water is no longer present in the form of drops but forms a surface film and may then easily be removed with the stream of gas.

The surface of graphite-filled polymers is in most cases wetted only poorly by water, the contact angles are typically >60°. The reason for this is a combination of hydrophobic properties of the graphitic fillers, but also of the polymeric binders, and release agents which may accumulate on the surface.

For reasons of better electrical contacting, it may be necessary to remove the polymer-rich and release agent-rich surface skin from the functional faces. Common methods are, inter alia, abrasive brushing, fine blasting, grinding and in particular also cleaning with an infrared laser. Most of these methods result in slight roughening of the surface. Given the hydrophobic properties of the graphite, this may even result in superhydrophobic surfaces (lotus effect) with contact angles >90°, from which drops of water roll off very easily.

Methods for coating or for modifying the surface are known from the literature. The overall objective is to create a sufficient number of polar functional groups, which are a requirement for good wetting properties:
There may be used as coating materials polar polymers (e.g. phenolic resins, crosslinked polyvinyl alcohol), to which finely divided polar fillers (e.g. pyrogenic silica, oxidized carbon blacks) may also be added.
In the borderline region between coating and surface modification there is treatment with a siloxane-containing plasma, which leads to the deposition of a very thin layer of pyrogenic silica.
The main objective, however, is direct oxidation of the graphite surfaces, wherein various methods are used:
   wet chemical oxidation with strong oxidizing acids or hydrogen peroxide
   dry oxidation in the gas phase with fluorine or sulfur trioxide
   atmospheric plasma treatment
   low-pressure plasma treatment
   corona treatment.
Coatings with polymeric binders may partially cover the graphitic fillers again and thus increase the electrical contact resistance. Furthermore, uniform coating of fine channel structures, especially in the case of systems containing fillers, is very difficult. The maintenance of very narrow tolerances of the channel geometries, which again is a necessary requirement for a uniform flow and a homogeneous material exchange, is thus no longer possible.
Sufficient layer adhesion which is maintained even on prolonged operation of the fuel cell cannot be ensured in the case of coatings with a low binder content. This applies even more in the case of the binder-free deposition of pyrogenic silica by way of a plasma treatment.
Oxidation with fluorine or sulfur trioxide in the gas phase may lead to a permanently hydrophilic surface modification but, owing to the toxicity of the gases, the treatment may only be carried out in hermetically sealed systems, which is a serious disadvantage for large-scale manufacture. Furthermore, treatment of part-surfaces is not possible or is possible only with very complex masking of the plates.
Plasma treatment, in particular at normal pressure, and the technologically related corona method, on the other hand, may very easily be integrated into a manufacturing process and in the short term also result in readily wettable surfaces with contact angles <15°. However, it has been shown that this state lasts for only a few hours or days. After a prolonged idle period, a largely steady state with moderate wettability and contact angles in the range of approximately from 25 to 50° is established.

The aim is permanently hydrophilic surfaces with contact angles of drops of water <25° by the use of an efficient manufacturing method which is suitable for use on a large-scale.

Surprisingly, it has been shown that permanently hydrophilic surfaces may be produced by means of the laser treatment, which may also be used to remove the polymer-rich surface skin. Contrary to the previous assumption that laser treatment tends to increase the hydrophobic properties, treatment with a sufficiently high pulse energy not only results in removal of the polymer skin, but also leads to a structural change of the graphite surface. Short intensive lasers evidently induce defects in the layer planes of the graphite particles that are close to the surface and, in an extreme case, lead to extensive destruction of the graphite crystals. The defects then spontaneously become saturated with oxygen and hydroxyl groups, which are a requirement for good wetting behavior.

The effect could first be demonstrated using an ultrashort pulse laser with pulse durations of approximately 15 ps and a pulse energy of approximately 0.4 mJ. However, owing to the limited power and the comparatively high costs, the use of ultrashort pulse lasers is mostly ruled out in the case of the large-scale manufacture of bipolar plates. Surprisingly, however, it was then shown that comparable surface properties may also be established using pulsed nanosecond fiber lasers if the pulse energy is at a comparable level, even though the individual pulse powers, at approximately 30 MW and 5 kW, respectively, differ by more than three orders of magnitude. The pulse energy per unit area should apparently exceed a critical value. In the cases described, that value was approximately from 0.3 to 0.7 J/mm²; the lower limit has not yet been determined precisely. Nanosecond fiber lasers are state of the art in different power classes and may easily be scaled for large-scale use.

Permanently hydrophilic properties would possibly also be possible through the combination of fillers having a low degree of graphitization and a plasma or corona treatment following the laser treatment with lower pulse energy. The fillers would then already have a sufficient number of defects, which are required to form the polar surface groups in the oxidizing treatment. As a result, however, the material as a whole then also has a low electrical and thermal conductivity and an additional manufacturing step is again required.

Finally, it should be noted that terms such as “having”, “comprising”, etc. do not exclude any other elements or steps and the term “one” does not exclude a plurality. It should further be pointed out that features or steps which have been described with reference to one of the above exemplary embodiments may also be used in combination with other features or steps of other exemplary embodiments described above. Reference numerals in the claims are not to be regarded as a limitation.

### LIST OF REFERENCE NUMERALS

1 bipolar plate
3 surface to be rendered hydrophilic
5 substrate
7 graphite-containing material
9 part-region
11 pulsed laser
13 nanosecond fiber laser
15 laser beam
17 exposure region
19 fuel cell
21 cell stack
23 fuel cell system
25 energy storage arrangement

1-15. (canceled)

16. A method for forming a hydrophilic surface on a graphite-containing material, wherein the surface to be rendered hydrophilic is irradiated with a pulsed laser having a power density of at least 0.5 MW/mm².

17. The method according to claim 16,
wherein the pulsed laser irradiates the surface to be rendered hydrophilic with pulses having a pulse energy per unit area of at least 0.1 J/mm².

18. The method according to claim 16,
wherein the pulsed laser irradiates the surface to be rendered hydrophilic with pulses having a pulse energy per unit area of less than 1 J/mm².

19. The method according to claim 16,
wherein the pulsed laser irradiates the surface to be rendered hydrophilic with pulses having a pulse duration of less than 1 μs.

20. The method according to claim 16,
wherein the pulsed laser irradiates the surface to be rendered hydrophilic with a pulse frequency of less than 100 kHz.

21. The method according to claim 16,
wherein the pulsed laser irradiates the surface to be rendered hydrophilic with wavelengths of between 800 nm and 1500 nm.

22. The method according to claim 16,
wherein the surface to be rendered hydrophilic is exposed to a reactive gas atmosphere during the irradiation.

23. The method according to claim 16,
wherein the graphite-containing material has graphite particles which are embedded in a polymer matrix.

24. The method according to claim 16,
wherein the pulsed laser is additionally also used to remove from the graphite-containing material a superficial polymer layer and/or surface layer which consists of a material other than the graphite-containing material.

25. The method according to claim 24,
wherein the removal of the polymer layer and/or surface layer is carried out with same laser parameters as the formation of the hydrophilic surface.

26. The method according to claim 16,
wherein the graphite-containing material has a graphite content of at least 60 vol. %.

27. The method according to claim 16,
wherein the graphite-containing material has a polymer content of at least 20 vol. %.

28. The method for manufacturing a bipolar plate of a fuel cell or of a flow battery, wherein the method comprises:
providing a plate-like substrate which, at least adjacent to an exposed surface of the substrate, consists of a graphite-containing material, and
forming at least part-regions of the exposed surface as a hydrophilic surface by means of the method according to claim 16.

29. A bipolar plate of a fuel cell or of a flow battery, which bipolar plate has been manufactured by the method according to claim 28.

30. An energy storage arrangement, in particular having at least one fuel cell or flow battery, having a bipolar plate according to claim 29.
